(19) United States
(12) Patent Application Publication
(10) Pub. No.: US 2007/0186252 A1
(43) Pub. Date: Aug. 9, 2007

(54) Method and system for home shopping using video-on-demand services

(76) Inventor: Frank S. Maggio, St. Petersburg, FL (US)

Correspondence Address: KING & SPALDING LLP, 1180 PEACHTREE STREET, ATLANTA, GA, 30309-3521, US

(21) Appl. No.: 11/348,750

(22) Filed: Feb. 7, 2006

(51) Int. Cl. H04N 7/173; G06F 13/00; G06F 3/00; H04N 5/445; G06Q 10/00

(52) U.S. Cl. 725/86; 725/87; 725/60; 725/61; 725/45; 705/28

(57) ABSTRACT

A network can provide consumers with remotely accessible video content selections, each presenting one or more sales offers. Consumers can send or transmit a prompt, request, message, or demand that triggers the transmission or downloading of video content for viewing, such as on television systems in consumer homes. As consumers place orders for a featured product in response to viewing the downloaded video content, the stock, supply, availability, or inventory of that product can change. While the video plays or shows, the television systems can receive dynamic, live, or up-to-date information, for example, current inventory data that reflects consumer orders. The television system can present that information, or a derivative thereof, to the consumer, for example, notifying the consumer of a limited-supply condition, showing an inventory count in a field of the video, or offering a substitute product when a stock level becomes depleted.

### RELATED APPLICATIONS

This application is related to U.S. patent application No. 10/976,149, which was filed on Oct. 28, 2004, published as U.S. Patent Application Publication Number 2005/0060232 on Mar. 17, 2005 to Maggio, and entitled “Method and System for Interacting with a Writing,” the contents of which are hereby fully incorporated herein by reference.

This application is related to the commonly owned U.S. non-provisional patent entitled “Method and System for Interacting With On-Demand Video Content,” having attorney docket number 58368.105019, and filed on Feb. 7, 2006, the contents of which are hereby fully incorporated herein by reference.

### TECHNICAL FIELD

The present invention relates to providing downloadable video that supports home shopping and more specifically to video-on-demand services in which a consumer can remotely access a video featuring a product for sale and can obtain dynamic information related to the featured product, such as real time inventory data, while the video is playing on a television set.

### BACKGROUND

Television audiences often select and view programming content that a distribution network broadcasts to multiple homes or viewing sites. The broadcast distribution network may transmit signals over a cable system, via satellite, or through the air. Those signals typically carry multiple programs at the same time, with each program having a distinct range of signal frequencies. Thus, at any given time, the distribution network presents each household television with multiple programs that are simultaneously airing. An audience member can view a program of interest by selecting the appropriate channel that tunes the television to receive the signal frequencies that carry the program. When the audience member “tunes in” to a selected channel, the television typically shows the portion of the program that is airing at that time. In other words, television viewers typically watch programs as they broadcast over the network.

Those broadcast programs can provide entertainment or information about a product or service that the audience member may have an interest in acquiring. The audience member may be a consumer that is interested in purchasing a product featured on an infomercial or a home shopping program. In response to viewing a program about the product, the consumer may elect to place an order for the product. The consumer may make a telephone call, access an Internet site, or use an interactive television capability to order the product while the program is airing. The business entity that is offering the product for sale receives and logs the order and reduces its available inventory accordingly. Broadcast home shopping programs, such as the programs produced by HSN, a subsidiary of IAC/InterActiveCorp of St. Petersburg, Fla., often show sales or inventory information about a featured product during a live broadcast. The programs may show a count of received orders or an inventory of items that remain available for purchase. In response to receiving orders, the program may update the count audibly or visually in an area of the displayed picture. Knowing the amount of inventory remaining available can positively influence consumer purchasing decisions. The producer of the program can use a tally of purchasing activity or a count of available inventory as feedback for the program. A spokesperson selling a product in a live broadcast may ad lib. based on available inventory, for example, terminating a sale offer to coincide with exhausting the inventory.

While live broadcast television programs generally provide a vehicle through which a consumer can obtain dynamic information about sales or inventory of a featured product, the audience often has limited flexibility to select viewing times. With conventional broadcast technology, viewers frequently need to schedule viewing activities to coincide with time slots in a broadcast schedule. To provide audiences with enhanced viewing flexibility for entertainment programming, a trend is emerging to provide audience members with videos or programming content on demand. A user with a television linked to a video-on-demand (“VOD”) network can access a library of prerecorded programming on an as-needed basis or at essentially any convenient time. The user can select a prerecorded entertainment program for downloading over the VOD network from a remote server. The program, in the form of video signals, arrives at a set top box for local storage or buffering. The set top box processes and feeds the video signals to an associated television set that shows the selected entertainment program. Thus, VOD-based television systems typically remotely access and play prerecorded video content.

While VOD networks afford users schedule flexibility for viewing entertainment, conventional VOD technology generally provides limited or insufficient capabilities to adequately support home shopping. As discussed above, programs that offer products for sale to consumers should preferentially have a capability to present dynamic information related to sales volume or product inventory, and conventional VOD programs do not support that capability. That is, although conventional VOD technology supports presenting a viewer with prerecorded content in response to a viewer request, that conventional technology lacks a capability to respond to sales events or a capability to integrate programming that offers products for sale with dynamic inventory or sales information. Thus, inventory management issues, such as having sufficient product available to meet sales demands, often preclude selling products over a communication network using prerecorded sales content.

The constraint of airing home shopping segments live often limits the amount of resources that a “shopping network” business can invest in creating and producing home shopping programs. Since conventional home shopping programs are not readily recorded and rebroadcast, each program needs to achieve profitability through a single broadcast. Accordingly, the shopping network usually can not afford to pay celebrities to routinely appear on live broadcasts. Because a conventional home shopping program has limited or no shelf life, a producer's investment in on-air talent essentially expires with the airing of the program. Celebrity appearances may be limited to times that coincide with peak viewing or to periods when high order volume is expected. When the shopping network commissions a prominent celebrity to make a live appearance, the celebrity may receive a level of compensation that erodes the shopping network's profit or that is higher than the shopping network desires. For example, the celebrity may be able to negotiate a heavy share of sales rather than a modest hourly rate that the shopping network would prefer.

Another problem that impedes shopping networks from vending products using on-demand access to prerecorded sales content is the organization of that content. Consumers are accustomed to purchasing by product type or by department, and existing technology for delivering on-demand videos fails to satisfactorily organize shopping content. A conventional shopping network might dedicate certain times or special events to focused marketing of categories of products, such as a jewelry hour or a weekend that features decorating products. However, since on-demand content is somewhat unscheduled, conventional methods for organizing live home shopping programs on a time basis do not readily apply to on-demand shopping programs.

Traditional bricks-and-mortar shopping malls have physical buildings in which a shopper can walk and window shop, for example. Shoppers find traditional shopping malls appealing at least in part because a shopper can conveniently visit specialty stores or store departments that specialize in particular categories or types of products. A mall store might specialize in beauty aids, shoes, golf supplies, sporting goods, flowers, or nutritional supplements, for example. The shopper can conveniently and efficiently visit stores of interest and purchase needed or wanted gifts or other items. Conventional systems for organizing video content or home shopping programs are not well tailored to emulating the shopping experience that traditional shopping malls provide. While purchasing goods through a conventional communication network offers the luxury of shopping from home, the benefits of traditional shopping malls continues to draw shoppers.

To address those representative deficiencies in the art, a need exists for providing on-demand video content that offers products for sale and that can provide a viewer with dynamic, real time, live, or current information related to sales volume or changes in product inventory. Another need exists for integrating dynamic, real time, live, or updated data or content with prerecorded content. Another need exists for organizing or categorizing on-demand videos, such as on-demand shopping videos, to help viewers select the appropriate video. Another need exists for a capability for viewers to interact with on-demand video content. Another need exists to reuse home shopping video content. A capability fulfilling one or more of those needs would support home shopping in a VOD environment.

### SUMMARY OF THE INVENTION

The present invention supports offering television viewers on-demand video content that features a product for sale and that provides dynamic information related to product availability or sales events occurring while those videos are playing. Integrating, combining, associating, or aggregating dynamic inventory or product supply information with downloaded video content can support home shopping in a VOD environment.

In one aspect of the present invention, a video distribution network, such as a VOD network, can offer consumers, users, or potential viewers downloadable or remotely accessible video selections, each presenting one or more products for sale. A consumer with an interest in one of the products can select a video featuring that product for showing or playing at a viewing site, such as the consumer's home or residence. In connection with making the selection, the consumer or a device that the consumer controls can send or transmit a prompt, request, message, or demand that triggers remote access to the selected video. A signal representation of the selected video can transmit over the network or download from a server or another storage facility, for example. A television system or a set top box associated with a television set can receive and play the transmitted video. The network can transmit multiple copies or instances of the video to respective consumers, so that consumers at different sites view the same prerecorded video content during an overlapping timeframe. A consumer at one site can place an order for a product while another consumer at another site contemplates purchasing the product as he or she views the video featuring that product. As consumers at various sites place orders for a featured product in response to viewing a downloaded video, the stock, supply, availability, or inventory of that product can change. While the video plays or shows at multiple sites, the respective television systems of those sites can receive dynamic, up-to-date, real time, or current information regarding inventory levels. That information can reflect or account for orders received from multiple sites on a video distribution network. Each respective television system can present inventory information, or a derivative thereof, to its consumer viewer. For example, each television might notify its viewer of a limited-supply condition or offer an alternative video about a substitute product when stock level dwindles. As another example, each television might show an inventory count in a field of the video or on an area of a television screen. As yet another example, some aspect of the video content might vary in response to a changing inventory condition or to another stimulus. As yet another example, the television system or an associated media device might present the viewer with a query or question about some aspect the video or the video's content.

Other aspects, systems, methods, features, advantages, and objects of the present invention will become apparent to one with skill in the art upon examination of the following drawings and detailed description. It is intended that all such aspects, systems, methods, features, advantages, and objects are included within this description, are within the scope of the present invention, and are protected by the accompanying claims.

### BRIEF DESCRIPTION OF THE DRAWINGS

FIG. 1 is an illustration showing an exemplary hierarchical categorization of on-demand videos offering products for sale according to an embodiment of the present invention.

FIG. 2 is an illustration of a television monitor playing an exemplary on-demand video that presents prerecorded shopping content and dynamic data related to sales and inventory according to an embodiment of the present invention.

FIG. 3 is functional block diagram of an exemplary system for providing on-demand shopping videos that present prerecorded content integrated with dynamic content according to an embodiment of the present invention.

FIGS. 4A and 4B, collectively FIG. 4, are a flow diagram illustrating an exemplary process for providing on-demand shopping videos to consumers according to an embodiment of the present invention.

FIG. 5 is a flow diagram illustrating an exemplary process in which a system that provides on-demand shopping videos responds to a low-inventory condition according to an embodiment of the present invention.

FIG. 6 is a flow diagram illustrating an exemplary process for providing on-demand shopping videos that present prerecorded content integrated with dynamic inventory data according to an embodiment of the present invention.

FIG. 7 is an illustration of an exemplary handheld remote control device that presents a consumer with questions about a shopping video according to an embodiment of the present invention.

FIG. 8 is a flow diagram illustrating an exemplary process in which a consumer interacts with on-demand video content according to an embodiment of the present invention.

FIG. 9 is a flow diagram illustrating an exemplary process for offering a consumer a categorized list of on-demand shopping videos according to an embodiment of the present invention.

Many aspects of the invention can be better understood with reference to the above drawings. The components in the drawings are not necessarily to scale, emphasis instead being placed upon clearly illustrating the principles of exemplary embodiments of the present invention. Moreover, in the drawings, reference numerals designate corresponding, but not necessarily identical, parts throughout the different views.

### DETAILED DESCRIPTION OF THE EXEMPLARY EMBODIMENTS

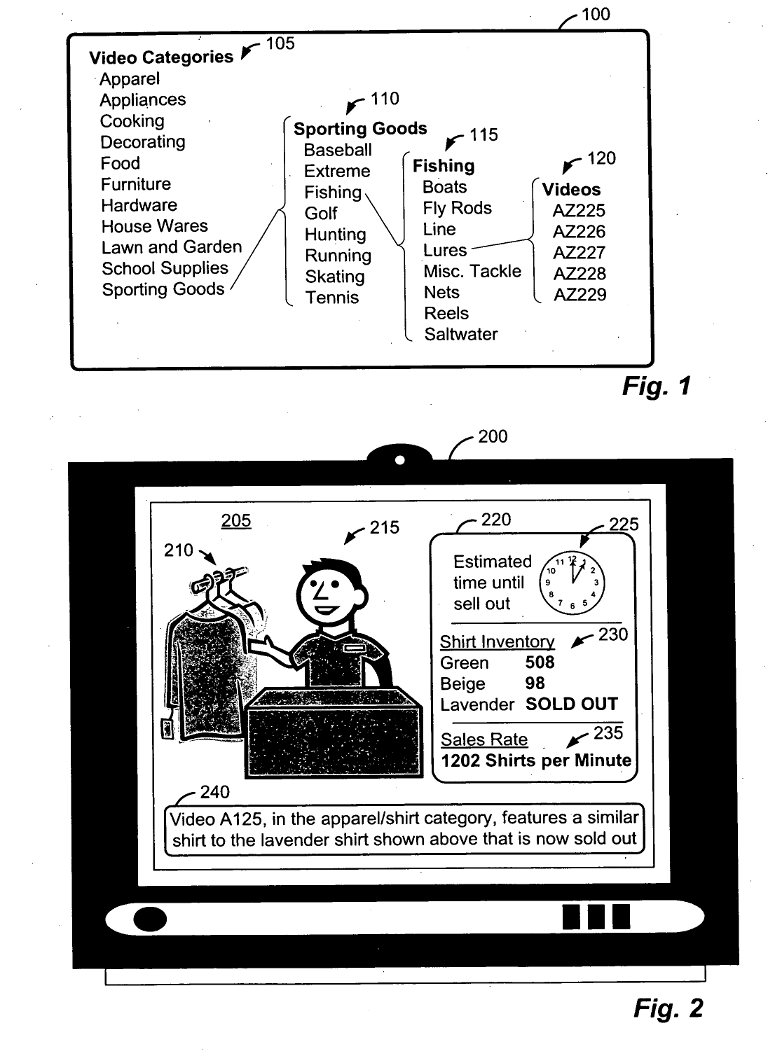

Exemplary embodiments of the present invention can provide a television viewer with an on-demand video that presents a sales offer for a product, item, good, or service and that responds to sales events, such as presenting dynamic sales or inventory data to the viewer. A method and system for providing remotely accessible shopping videos on a television that shows dynamic information in connection with prerecorded shopping content will now be described more fully hereinafter with reference to FIGS. 1-9, which show exemplary embodiments of the invention.

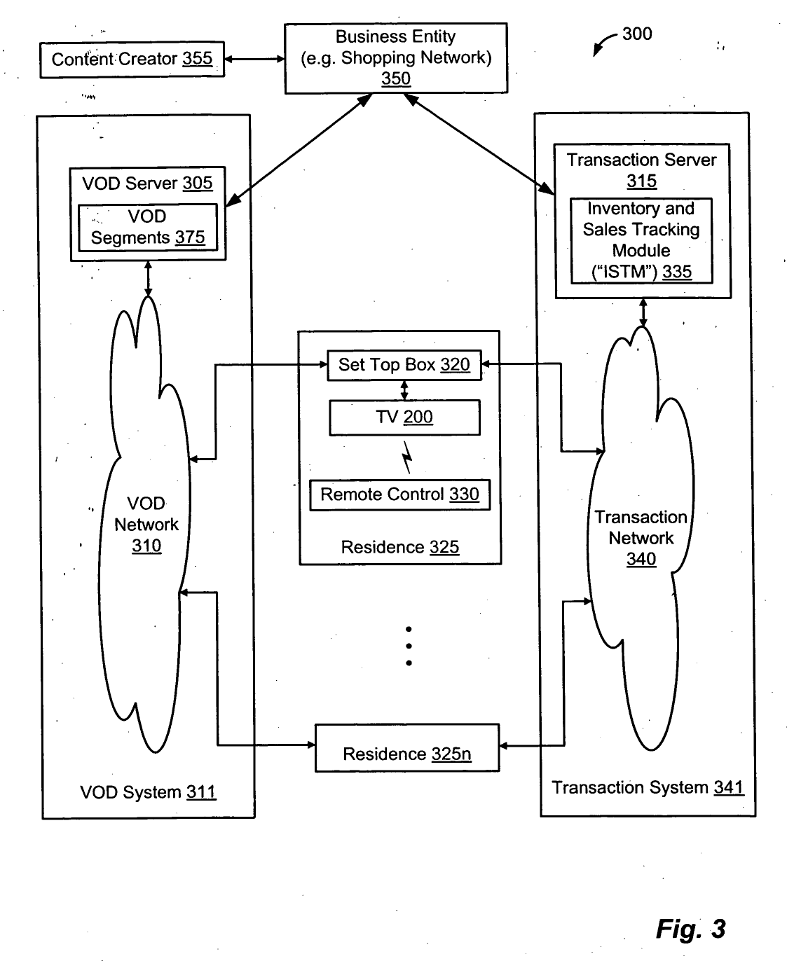

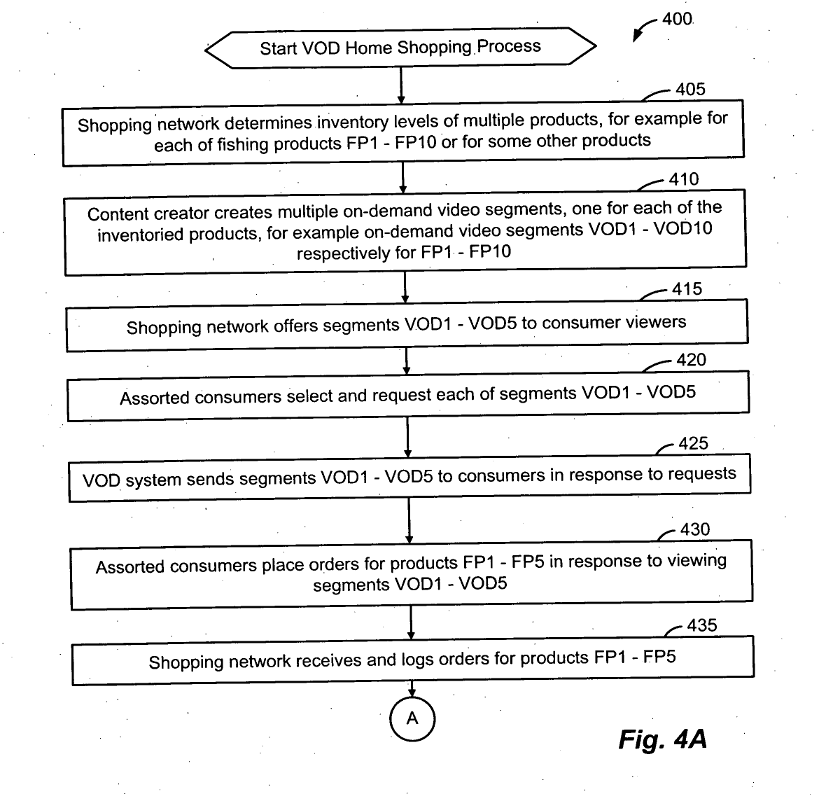

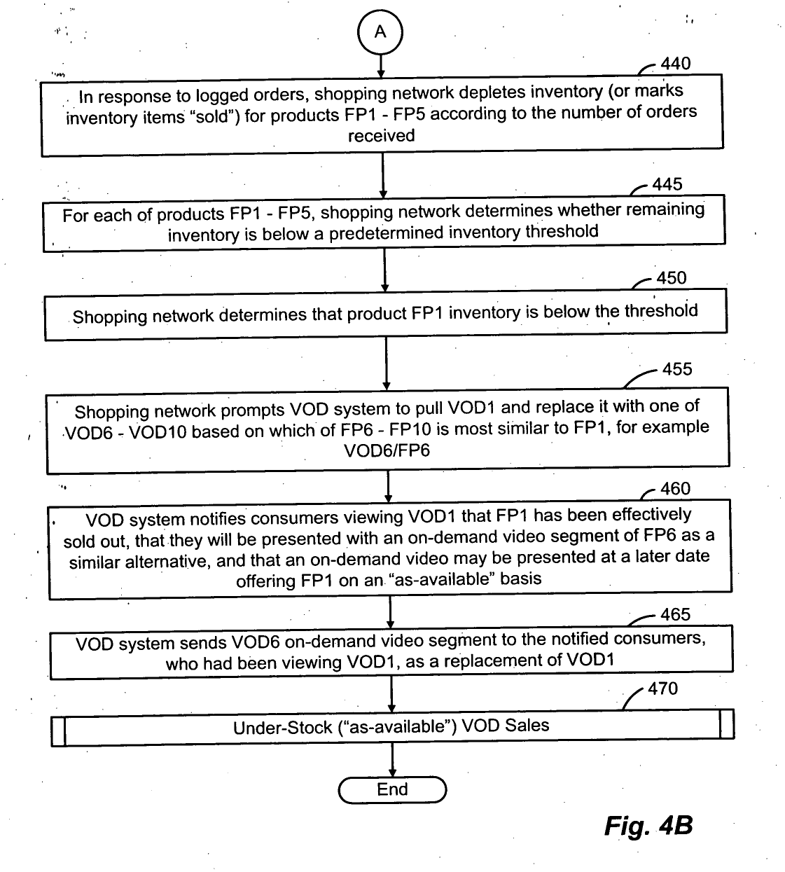

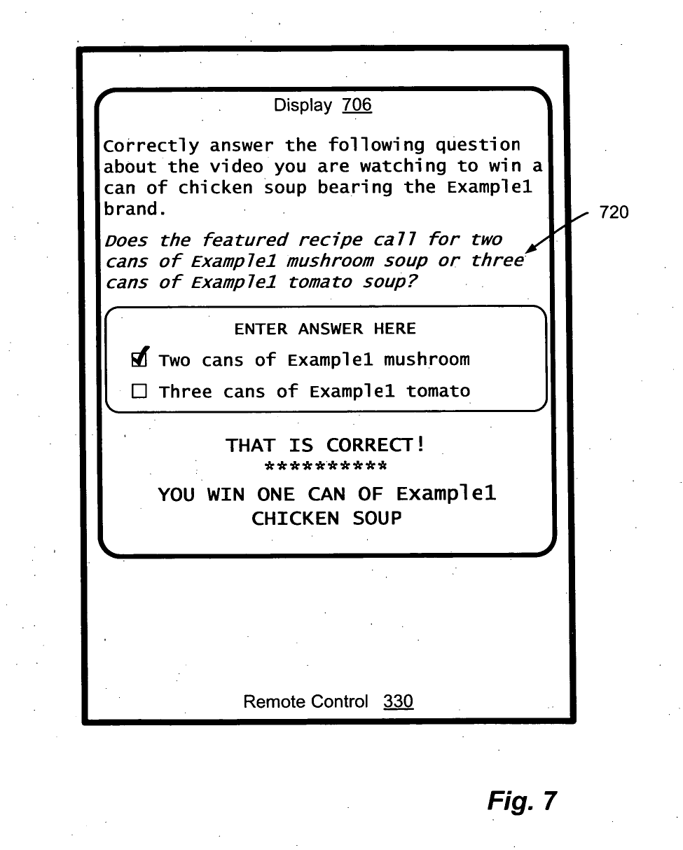

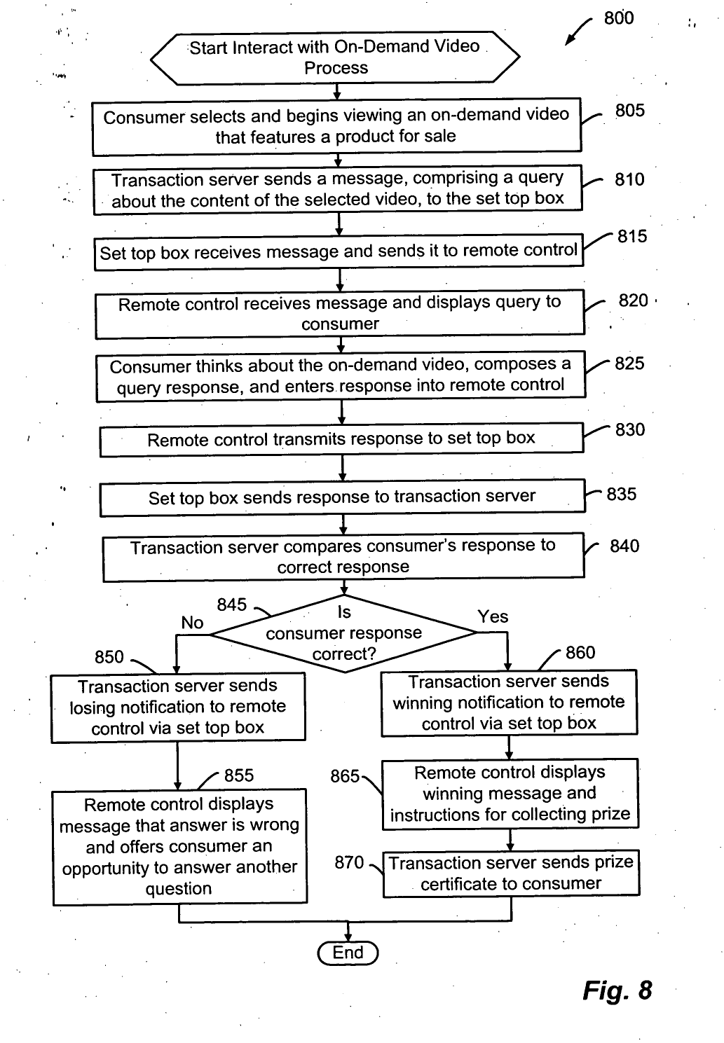

FIG. 1 provides an exemplary tree diagram or schema for organizing home shopping videos according to subject or genre. FIG. 2 provides an exemplary television screen for home shopping in a VOD environment. FIG. 3 provides an illustration of an exemplary network for distributing on-demand shopping videos. FIGS. 4, 5, 6, and 9 present flowcharts of exemplary processes relating to providing on-demand shopping videos. FIGS. 7 and 8 respectively illustrate an exemplary remote control and an exemplary process for interacting with on-demand shopping videos.

The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” given herein are intended to be non-limiting, and among others supported by exemplary embodiments of the present invention.

Turning now to FIG. 1, this figure illustrates an hierarchical categorization 100 of on-demand videos offering products for sale in accordance with an exemplary embodiment of the present invention. A consumer can view the categories on a television screen, a computer terminal, or an interactive remote control that is accessible during viewing activities. Thus, FIG. 1 provides an illustration of an exemplary user interface through which the consumer can efficiently select shopping videos. Categorizing the on-demand shopping videos can comprise grouping, classifying, or organizing the videos according to subject matter, viewer taste, shopping departments, genre, or commonality of a feature, usage, or function of a featured product (not an exhaustive list).

In one exemplary embodiment of the present invention, on-demand shopping videos are categorized according to the demographics of the consumers that each video targets. In one exemplary embodiment of the present invention, each category of on-demand shopping video is associated with a demographic profile of the consumers that are likely to find the contents of the category appealing.

A cable multi-system operator (“MSO”) can warehouse a virtual mall of shopping genres on a VOD server. The consumer can immediately access a video of a specific genre by selecting a category offering and then hitting “enter” using a remote control or a pointing device. In this manner, each genre can be likened to a specialty store at a traditional bricks-and-mortal shopping mall. As a result, a shopping experience based on on-demand videos can emulate, replicate, or simulate the familiar shopping experience of walking through a traditional shopping mall. Further, the shopper can enjoy the efficiency and convenience of shopping from home.

The hierarchical categorization 100 helps consumers efficiently select one or more videos when a purchasing desire for a particular type of product or item arises. The consumers are typically geographically dispersed and linked to one or more central sites that maintain a library, collection, or archive of videos for remote access. If planning a fishing trip, for example, the consumer can select the Sporting Goods Category 110 to trigger an expansion of the topics or subjects in that category 110. The category expansion can occur in a popup window, a drag-down menu, a display bar, in a separate screen, or via an expanding outline, to name a few possibilities.

Within the Sporting Goods Category 110, the consumer can select the Fishing Category 115 to explore the product types within that category. If interested in fishing plugs, the consumer can select the Lures Category 120, to show a list of lure videos 120. While FIG. 1 illustrates those lure videos 120 by an alphanumeric code, other types of identifiers or descriptors may appear on a user interface. For example, video names or product brand names can distinguish or describe the videos 120.

Categorizing videos or video content according to subject matter or genre can benefit various types of on-demand videos services and applications beyond shopping videos. For example, a VOD system can present an audience of consumers or other viewers with on-demand movies, entertainment, promotions, advertisements, or educational materials categorized by subject matter or organized in a tree. A VOD network can deliver such content on a “pay-per-view” basis, without charge, in exchange for advertising, or in accordance with other business terms or economic incentives.

The term “video-on-demand network” or “VOD network,” as used herein, refers to a system that is operable to provide moving images from storage to a viewing site in response to a request, demand, message, or prompt initiated at that viewing site. Videos comprising the moving images can be held at or on a storage facility comprising a server, an archive, a mass storage device, a machine-readable medium, or a video library, to name a few examples. Electrical, optical, or electromagnetic signals, or a combination thereof, typically convey or carry the moving images from a storage site to the viewing site.

The term “on-demand video,” as used herein, refers to content comprising moving images that a user at one site can download or otherwise access from another site.

The term “video-on-demand” or “VOD,” as used herein, refers to a descriptor or adjective for remotely accessing video or moving image content from a remote site on an as needed basis, upon entry of a request, in response to sending a message, via a prompt, or at the discretion of a user or a viewer.

Turning now to FIG. 2, this figure illustrates a television monitor 205 playing an on-demand video that presents prerecorded shopping content 210, 215 and dynamic data 225, 230, 235, 240 related to sales or inventory in accordance with an exemplary embodiment of the present invention.

The video shown playing in FIG. 2 can be a selection from a catalog or menu of on-demand videos 100 organized according to subject matter or product type, as illustrated in FIG. 1 and discussed above. As shown in FIG. 2, the consumer could have selected an on-demand video segment from the Apparel Section of the Video Categories 105.

In response to the consumer selecting the on-demand video, a remote archive, storage facility, machine-readable medium, or server downloads prerecorded video content 210, 215 or otherwise makes content available for viewing on the consumer's television 200. In addition to the prerecorded content 210, 215, the monitor or screen 205 of the television 200 shows dynamic information 225, 230, 235, 240 that changes or is updated while the video is playing. That is, the content that the consumer views comprises prerecorded images 210, 215 and live data 225, 230, 235, 240. Some aspect of the live data 225, 230, 235, 240 can change between the start of the video and the end of the video in a manner that is unknown a priori or before the start of the video with certainty. Thus, the live data 225, 230, 235, 240 can change in response to an event connected with showing the video. Furthermore, the live data 225, 230, 235, 240 can comprise a consumer or viewer response to a video presentation.

The displayed content comprises a moving image of a sales person 215 delivering a sales presentation or a pitch for green, beige, and lavender shirts 210. In response to viewing the sales pitch, the consumer can elect to place an order for one or more of the shirts 210. The consumer may order the item telephonically, through an Internet connection to a website, using a wireless link to a remote host, or via another communication link or medium.

Often, consumers at various sites view the same on-demand shopping video at essentially the same time. For example, while a consumer at one site is viewing the midpoint of the on-demand video, another consumer at a different site might be viewing a concluding segment of that video. With consumers at various sites placing product orders at random times, the inventory of the shirts 210 can diminish, thereby impacting product availability or the capacity of the video producer or sponsor to fill orders.

The television monitor 205 presents an area or window 220 with updatable fields that show dynamic inventory and sales data 225, 230, 235 of interest to the consumer. The inventory section 230 provides a count of the current shirt inventory that remains available for purchase. As various consumers place orders for shirts and the shirt stock diminishes, the inventory count changes until reaching a sold-out condition. At the time that FIG. 2 illustrates, 508 green shirts and 98 beige shirts remain in stock and available for purchase, while the lavender shirts have all been sold.

The dynamic window 220 has an area 235 that shows the consumer the sales rate of shirts, in this example 1202 shirts per minute. Providing sales information to the consumer can positively influence a purchasing decision, for example triggering the consumer to buy an item that is selling quickly.

A time gauge 225 or clock shows the consumer an estimate of the time that remains until the shirt inventory is fully depleted. The estimate can be derived by dividing the inventory by the sales rate. As a sell out condition approaches, purchasing activity can accelerate in a manner that benefits the shirt vendor.

When the stock of lavender shirts sells out or when lavender shirt inventory drops below a specified threshold, a message 240 appears on the screen 205. The message 240 informs the consumer that another on-demand video features an item that may be a viable replacement for the sold-out shirt. If the consumer elects to obtain that on-demand video or to purchase the recommended replacement, the consumer may be eligible for a discount.

In an alternative embodiment, the message 240 can alert the consumer that the supply is too low to ensure availability. When inventory is insufficient to meet demand, an item may be placed on backorder or an order can be rejected.

Beyond providing current or up-to-date inventory data 225, 230, 235, 240 inserted in or overlaid on the viewing screen 205, sales or inventory event data can support video feedback. In one exemplary embodiment of the present invention, some aspect of the on-demand video presentation changes as a result of a purchasing event that occurs during or in connection with a showing of the on-demand video. The consumer viewing a specific instance of the on-demand video can initiate the purchasing event. Alternatively, another consumer associated with a different television, for example in a different town or neighborhood, can initiate the purchasing event.

Turning now to FIG. 3, this figure illustrates a functional block diagram of a system 300 for providing on-demand shopping videos that present prerecorded content integrated with dynamic data in accordance with an exemplary embodiment of the present invention. That is, the system 300 can generate the images, text, and graphics and the underlying data illustrated in FIGS. 1 and 2 and discussed above.

The system 300 comprises a VOD system 311 and a transaction system 341. Via the VOD system 311 and the transaction system 341, the system 300 can serve a community, city, state, or region of a country populated with numerous residences 325, 325n.

A business entity, such as a shopping network 350 that uses on-demand videos to market, sell, advertise, or promote goods of commerce, such as products and/or services, links or couples to the VOD system 311 and the transaction system 341. The linkages between the shopping network 350 and the VOD system 311 and the transaction system 341 can be direct or may comprise an intermediary, such as another business entity or a cable operator. A content creator 355 typically produces the on-demand videos for the shopping network 350 as an internal department or as a contractor, for example.

The VOD system 311 comprises a VOD network 310 and a VOD server 305 that stores prerecorded video content or VOD segments 375. The VOD network 310 links a plurality of residences 325, 325n to the VOD server 305.

The transaction system 341 comprises a transaction server 315 and a transaction network 340. An inventory and sales tracking module 335 associated with or executing at the transaction server 315 tracks and accounts for purchasing transactions or sales events initiated at the residences 325, 325n. The transaction network 340 links the residences 325, 235n to the transaction server 315.

The residences 325, 325n can be geographically dispersed or can be concentrated in a locale, such as a town, neighborhood, or community. In one exemplary embodiment of the present invention, the residences 325, 325n are geographically dispersed but share a common demographic characteristic, such as a socioeconomic standard. The present invention is not limited to a specific number of residences 325, 325n, but rather can support an arbitrary number. The system 300 can comprise a single residence, several residences, several hundred residences, or many thousand residences 325, 325n. In exemplary embodiments, each of the residences 325, 325n can comprise a person's home, a hotel, a restaurant, a bar, a lobby, an airport waiting area, or another suitable location for remotely accessing and viewing a video.

The illustrated functional blocks 320, 200, 330 of the residence 325 are representative of other residences 325n of the system 300. That is, each of the residences 325, 325n can have an entertainment system or a television system that comprises a set top box 320, a television 200, and a remote control 330.

The residences 325, 325n can be coupled to either or both of the transaction network 340 and the VOD networks 310 through a hardwire connection, a wireless connection, or another suitable facility to transfer signals. A hardwire connection can comprise coaxial cable, a fiber optic link, or another suitable connection. A wireless connection can comprise a satellite link, a radio frequency signal path, or another suitable connection.

The set top box 320 provides the television 200 with connectivity to the VOD network 310 and the transaction network 340. Thus, the set top box 320 can provide, comprise, or be a video interface supporting that connectivity. The set top box 320 can be housed separately from the television 200, as a unit placed near, beside, or on top of the television 200. Alternatively, the set top box 320 can be an integral unit, subsystem, or module of the television 200, for example circuitry, software, and components that are internal to the television 200. In one exemplary embodiment, the set top box 320 comprises functionality dispersed among many components and subsystems of the television 200. Thus, in certain exemplary embodiments, the set top box 320 is not a single discrete element.

The consumer controls the set top box 320 and the television 200 with the remote control 330 that is typically handheld or portable. The remote control 330 can comprise an operability for interacting with remotely accessed video content, for placing purchase orders, or for responding to surveys or questions presented on an integral display or on the television 200.

The consumer can select an on-demand shopping video stored on the VOD server 305 by making a selection entry into the remote control 330. In response to receiving the consumer's video selection entry, the set top box 320 sends a message, prompt, or signal via the VOD network 310 to the VOD server 305. The VOD server 305 then makes prerecorded video content available to the set top box 320. The set top box 320 commences downloading and storing or buffering that content for presentation on the television 200.

The transaction server 315 maintains dynamic inventory or sales data and makes that data available to the set top box 320 via the transaction network 340. When a consumer at one of the residences 325, 325n places an order for a shirt 210, the order transmits over the transaction network 340 to the transaction server 315. An inventory and sales tracking module (“ISTM”) 335 at the transaction server 315 maintains a log of orders received, remaining inventory, and assorted purchase details. The transaction server 315 sends current sales and inventory data to the set top box 320 in response to a prompt, upon occurrence of a predefined event, at the consumer's request, or at regular time intervals, for example.

The set top box 320 integrates the dynamic sales data from the transaction server 315 with the prerecorded content from the VOD server 305. As discussed above, the image on the screen 205 of FIG. 2 illustrates an exemplary result of integrating static information maintained on the VOD server 305 with dynamic information maintained on, processed by, or associated with the transaction server 315.

The VOD server 305 and the transaction server 315 can be located at a common facility or site or can alternatively operate from distinct locations offsite from any specific residence 325. In one exemplary embodiment, a single server system provides the functions of the VOD server 305 and the transaction server 315. Thus, the VOD server 305 and the transaction server 315 can each be a virtual server of a common computing platform.

In one exemplary embodiment, the system 300 comprises a dedicated communication link (not shown on FIG. 3) between the transaction server 315 and the VOD server 305 that synchronizes the activities of these two server systems 305, 315. The communication link can coordinate the transmission of information from each of the systems 305, 315 to the set top box 320.

Either or both of the VOD network 310 and the transaction network 340 can comprise a public or a private network, a cable network, the Internet, an intranet, a local area network (“LAN”), a satellite network, a cellular network or another wireless network, the public switched telephone network (“PSTN”), a distributed computing network, an Internet protocol (“IP”) network, a wide area network (“WAN”), a personal video recorder network, a regional network, a metropolitan area network (“MAN”), and/or a packet switched network (not an exhaustive list).

Those experienced in the art will further recognize that numerous communications networks and systems (including presently available systems and future systems) may be substituted or interchanged with the VOD network 310 and the transaction network 340 or their respective servers 305, 315.

The VOD network 310 can be segregated from the transaction network 340 and/or isolated from the transaction network 340. In a segregated configuration, the signals that carry prerecorded video from the VOD server 305 to the set top box 320 avoid traveling along any substantive section of the path traveled by the signals that carry dynamic information from the transaction server 315 to the set top box 320. In another exemplary embodiment of the present invention, each of those signals can propagate in a common medium or a common network leg.

In one exemplary embodiment of the present invention, a single network, such as the Internet, comprises both the VOD network 310 and the transaction network 340. That is, a single network can provide the set top box 320 with connectivity to both the VOD server 305 and the transaction server 315. In this arrangement, the VOD network 310 and the transaction network 340 can each comprise a virtual network.

The system 300 can comprise any of the technologies disclosed in: 1) U.S. Pat. No. 6,055,560 to Mills et al., entitled “System and Method to Provide Interactivity for a Networked Video Server;” 2) U.S. Pat. No. 6,496,981 to Wistendahl et al., entitled “System for Converting Media Content for Interactive TV Use;” and 3) U.S. Patent Application Publication Number 2004/0098747 to Kay et al., entitled “Electronic Buying Guide Architecture.” Thus, an exemplary embodiment of the present invention can comprise one or more of the hardware elements, software, methods, systems, or network architectures disclosed in those three patent references. Further, the disclosure and teaching of those three patent references can support making and using exemplary embodiments of the present invention. The entire contents of U.S. Pat. No. 6,055,560, U.S. Pat. No. 6,496,981, and U.S. Patent Application Publication Number 2004/0098747 are hereby incorporated by reference.

The system 300 can further comprise or be supported by one or more of the interactive television products offered by GoldPocket Interactive, Inc. of Los Angeles, Calif. and Concurrent Computer Corporation of Atlanta, Ga. For example, the system 300 can comprise the Media-Hawk On-Demand platform and the MediaHawk Interactive Media Solution.

Turning now to FIG. 4, this figure illustrates a flow diagram of a process 400 for providing on-demand shopping videos to consumers in accordance with an exemplary embodiment of the present invention. The on-demand shopping videos can be or comprise the VOD segments 375 shown in FIG. 3, for example. When an inventory shortage or outage occurs for a product that a consumer has expressed an interest in purchasing, Process 400, which is entitled VOD Home Shopping, can provide the consumer with an on-demand shopping video for a substitute product.

At Step 405, the shopping network 350 determines the inventory level for each of a plurality of items of commerce. While those items could be almost any good or service or widget, for the purpose of illustrating and exemplary embodiment of the present invention, they will be referred to as ten fishing products, designated FP1-FP10. For example, each of FP1-FP10 could be a specific type and brand of saltwater tackle. The ISTM 335, which can comprise a software program, stores the inventory level at the transaction server 315. Thus, Step 405 can comprise initializing the ISTM 335.

The shopping network 350 uses videos to market and sell products, including the ten fishing products FP1-FP10. The shopping network 350 can be an operating division, subsidiary, or joint venture of a business entity that uses the VOD network 310 to provide a sales channel or a distribution outlet for a broader class of products. Thus, the shopping network 350 ascertains the stocks of FP1-FP10 that are available for purchase.

At Step 410, the content creator 355 produces and records ten videos for marketing and selling the ten fishing products. The ten VOD segments, VOD1-VOD10, respectively correspond to fishing products FP1-FP10. That is, video VODi comprises prerecorded content for marketing and selling FPi, where ‘i’ is an integer from one to ten. The content creator 355 might be a division of the shopping network 350, a partner of the shopping network 350, or a third party that the shopping network 350 hires for video production. The shopping network 350 places a digital or an analog copy of each of the ten videos on the VOD server 305.

At Step 415, the shopping network 350 offers five of the ten video segments, specifically VOD1-VOD5, for remote access and viewing via the VOD network 310 to a plurality of consumer residences 325, 325n. The shopping network 350 typically presents those video offerings to consumers in categories 105 arranged according to product type, for example as shown in FIG. 1 and discussed above. The Saltwater Section of the Fishing Category 115 contains VOD1-VOD5, for example.

At Step 420, consumers at various residences 325, 325n use their remote controls 330 to select each of VOD1-VOD5 based on an interest in purchasing saltwater fishing tackle. Each viewer request transmits to the VOD server 305 via the VOD network 310.

In one exemplary embodiment, the VOD server 305 allows an essentially unlimited number of copies of each video to be checked out at the same time. Alternatively, the VOD server 305 can limit the number of residences 325, 325n that can view each video during a common timeframe. In either case, a plurality of consumers may be viewing a specific one of VOD1-VOD5 at any given time.

The VOD server 305 receives the requests for VOD1-VOD5 at Step 425. In compliance with the requests, the VOD server 305 transmits or downloads the videos VOD1-VOD5 to the set top boxes 320 of the requesting parties, each of the residences 325, 325n that initiated a video request.

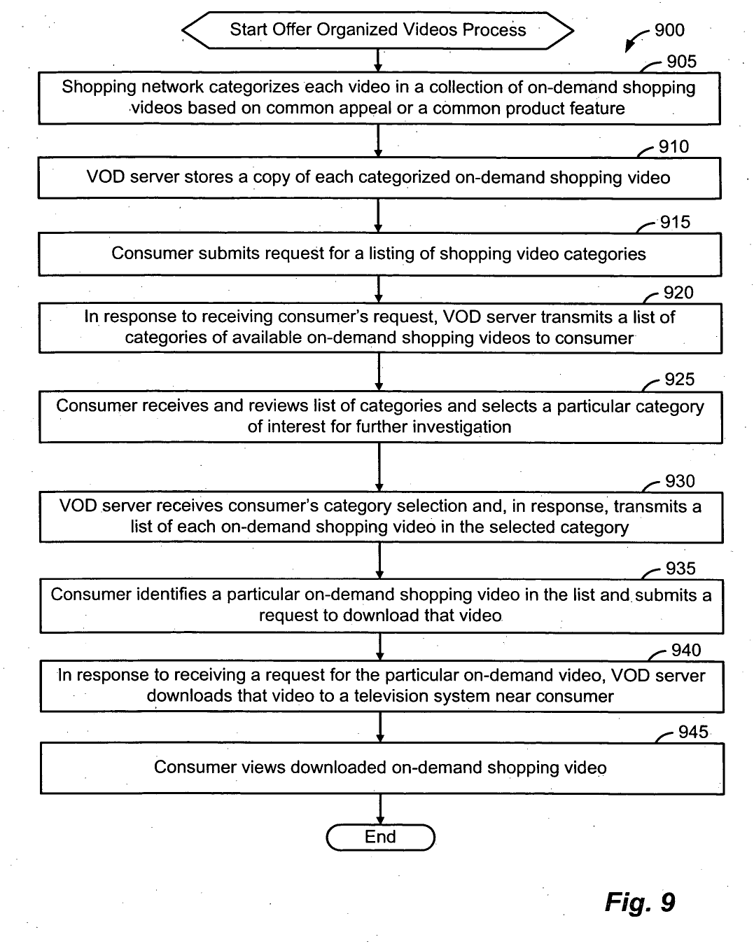

In one exemplary embodiment of the present invention, the process 900 illustrated in flow diagram form in FIG. 9 and discussed below replaces Steps 415, 420, and 425 of Process 400. In that embodiment, Process 900 offers viewers on-demand shopping videos categorized according to featured product, demographic appeal, genre, or some other criteria or criterion.

Referring now to FIG. 4, at Step 430, consumers at various residences 325, 325n or sites on the VOD network 310 view the downloaded videos VOD1-VOD5 and, in response, order fishing products FP1-FP5. Some of the consumers that view any specific video place an order, while others may elect not to order. Order placement for a specific product often occurs while the video that features that product is playing or shortly after its conclusion.

The shopping network 350, or an affiliate, receives the incoming orders for FP1-FP5 at Step 435. A ledger, order receiving system, or log that is coupled to the transaction server 315 takes and accounts for the orders. Thus, the ISTM 335 maintains order tracking records for consumer transactions.

At Step 440, the ISTM 335 adjusts its sales and inventory records to reflect incoming orders. The ISTM 335 decrements or diminishes its inventory count to reflect those orders. Thus, the shopping network 350 accounts for each purchasing event and reduces its inventory of available products accordingly.

At Step 445, the ISTM 335 determines whether the current inventory level of each of the saltwater fishing tackle products FP1-FP5 is below a threshold. That is, the shopping network 350 determines whether its current inventory level is sufficient to support ongoing marketing efforts and sales of those products.

At Step 450, the shopping network 350 determines that its product inventory of one of the products, specifically FP1, has been depleted or is insufficient. Thus, continued sales and marketing activities of FP1 may produce orders that the shopping network 350 lacks sufficient supply to fill.

At Step 455, the transaction server 315 sends a message to the VOD server 305 to terminate availability of VOD1, which features FP1, for downloading on the VOD network 310. In place of VOD1, the VOD server 305 substitutes another on-demand video or video segment that features a similar product to FP1. Specifically, the VOD server 305 uses a lookup table to select the product from FP6-FP10 that is most similar to FP5 or provides a common functionality for example. For example, the VOD server 305 can elect to offer VOD6, featuring FP6, as a substitute for VOD1/FP1.

The transaction server 315 can send the inventory depletion message to the VOD server 305 via a dedicated communication link, over a telephone line, or over the Internet, for example. Alternatively, that message can transmit from the transaction server 315 to the set top box 320 via the transaction network 340 and from the receiving set top box 320 to the VOD server 305 via the VOD network 310.

At Step 460, the VOD server 305 terminates the availability of VOD1 for remote access and offers VOD6 as a substitute to consumers interested in purchasing saltwater fishing tackle. The VOD server 305 also sends a message, alert, or notification to the set top boxes 320 that are currently playing VOD1 that a sold out condition exists or is approaching.

In response to receiving that message, those set top boxes 320 present an audible or visual message 240 on the screens 205 of their associated televisions 200 regarding the supply-shortage or supply-outage condition. The message 240 may recite that the product FP1 is sold out and that VOD6 features a similar product, FP6, that may be a viable substitute. The message 240 can also inform the consumer that order cancellation or other events may provide a small residual inventory that the shopping network 350 may offer at a future date on a limited or as-available basis. In one exemplary embodiment, the message 240 is graphical or textual in format and offers a discount for the substitute product or for any order that is subject to backordering.

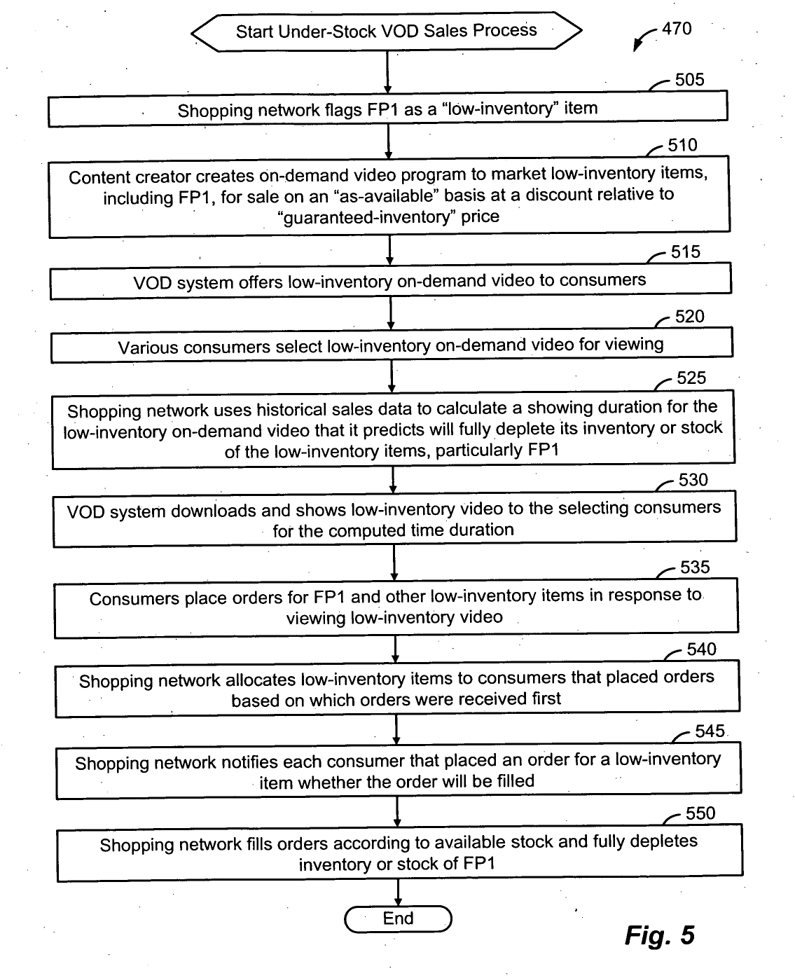

At Step 465, the VOD server 305 sends the substitute video, VOD6, to the appropriate set top boxes 320. At Step 470, the shopping network 350 proceeds to handle or dispose of any stock of FP1 that remains in inventory. FIG. 5 illustrates an exemplary embodiment of Step 470, which is entitled Under-Stock VOD Sales. Following Step 470, Process 400 ends.

In one exemplary embodiment of the present invention, the VOD server 305 stores multiple on-demand segments or VOD segments 375, each offering at least one distinct product (which could be a service) for sale. An on-demand video program may comprise a series or an ordered arrangement of two or more of the segments. Thus, an on-demand shopping video program can comprise multiple content segments about products in a common category, such as a fishing product category.

When a trigger event occurs, such as a low-inventory condition, the VOD server 305 can pull the relevant segment (or segments) from the program and replace that segment with another segment. Alternatively, the VOD server 305 can simply delete a selected segment, thereby shortening the program.

The VOD server 305 can make such a change to a program that has already been downloaded and is actively playing at a residence 325. Alternatively, the VOD server 305 can implement the program change to a stored version of the program, held on the server 305, so the revised program is available for downloading. Segments can be truncated, shortened, or automatically edited for time or content to support insertion of one segment into the time slot of another segment that was pulled or terminated due to an occurrence of an inventory event or a product supply condition. In this manner, on-demand video programs can be changed, updated, edited, or created in response to dynamic conditions, using content drawn from shorter on-demand programs or segments of prerecorded content. The changes can be implemented automatically, via computer processing, without direct human intervention, via man-machine collaboration, or manually, for example.

Turning now to FIG. 5, this figure illustrates a flow diagram of a process 470 in which a system 300 that provides on-demand shopping videos responds to a low-inventory condition in accordance with an exemplary embodiment of the present invention. In an exemplary embodiment of the present invention, the Process 470 can be a step, specifically Step 470, in Process 400, which FIG. 4 illustrates as discussed above. The on-demand shopping videos can be or comprise the VOD segments 375 illustrated in FIG. 3, for example

At Step 505, the transaction server 315 of the shopping network 350 flags or notes FP1 as a low-inventory item, thereby characterizing the supply of that product as potentially insufficient to meet new orders.

At Step 510, the content creator 355 produces an on-demand video program for marketing items with limited inventory. The on-demand video program can be or comprise a segment of prerecorded sales content. The video program features FP1, for which sales events occurring in association with Process 400 produced a low-inventory condition, as well as other low-inventory items. The low-inventory video program offers those products on an as-available basis at a price discount relative to merchandise that standard videos feature. That is, consumers can receive a discount for placing an order for featured items that may or may not be in stock.

At Step 515, the VOD server 305 offers the low-inventory video to consumers via the VOD network 310. At Step 520, consumers at various residences 325, 325n on the VOD network 310 select the low-inventory video for downloading and viewing.

At Step 525, the transaction server 315 uses prior sales data to predict a showing or playing duration for the low-inventory video that should fully deplete the remaining stock of the low-inventory items, particularly FP1. The transaction server 315 can compute a showing time or a duration for placing the low-inventory video on the categorized viewing window 100. Using sales records that the ISTM 335 maintains, the computation can scale the full-inventory sales rate of FP1 according to the historical sales rate that a previous low-inventory video achieved for a similar product.

By way of illustration, suppose another low-inventory video sold ten units of a similar fishing product per hour and that the standard video for that product sold twenty units per hour. Under those conditions, the computation could predict that a low-inventory video featuring FP1 would sell units of FP1 at one-half (50%) of its full-inventory sales rate. If fifty units of FP1 remain in inventory and VOD1 sold fifty units of FP1 per hour, then a two-hour showing time of the low-inventory video that features FP1 should sell fifty units of FP1, thereby exhausting the remaining inventory.

At Step 530, the shopping network 350 shows the low-inventory video for the computed time duration (e.g. two hours). The shopping network 350 can add a margin to the time estimate in order to increase the probability that the stock of FP1 will be fully consumed.

Consumers view the low-inventory video and place orders for FP1 at Step 535. At Step 540, the shopping network 350 accepts orders in the sequence of receipt or on a first-come-first-served basis. The transaction server 315 notifies each consumer that placed an order whether that order will be filled, backordered, or rejected on the basis of insufficient supply.

The shopping network 350 fills the orders for which it has sufficient stock, thereby fully depleting its inventory at Step 550. Process 470 ends following Step 550.

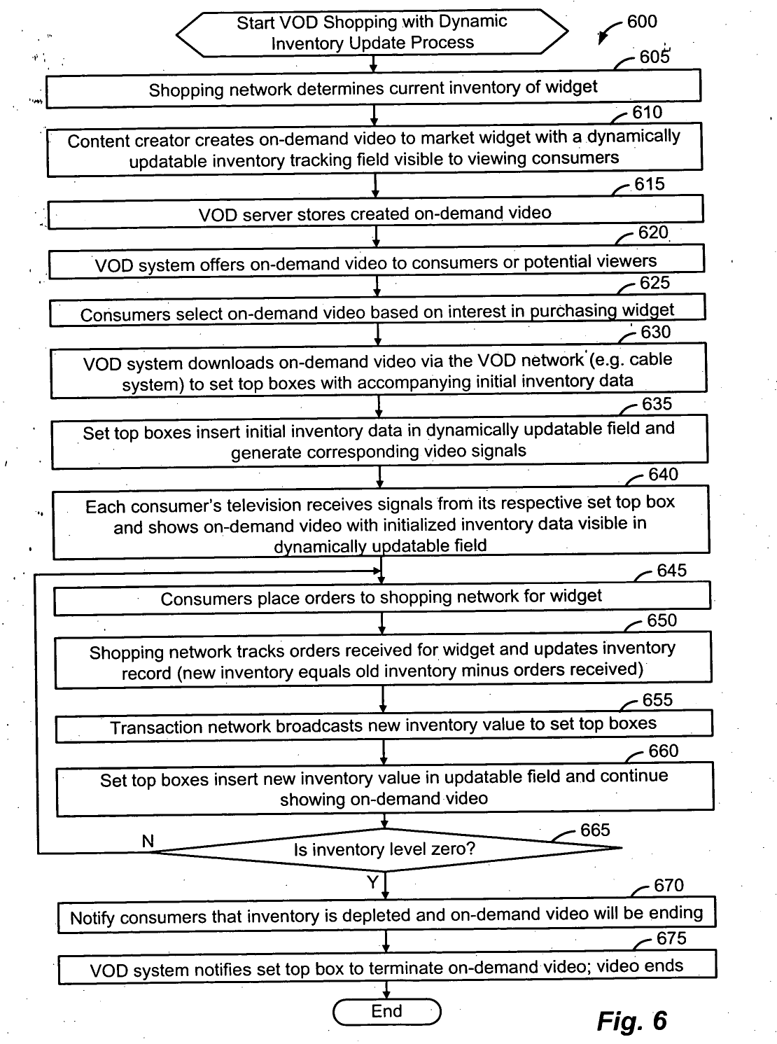

Turning now to FIG. 6, this figure illustrates a process 600 for providing on-demand shopping videos that present prerecorded content integrated with dynamic inventory data in accordance with an exemplary embodiment of the present invention. The Process 600, which is entitled VOD Shopping with Dynamic Inventory Update, can provide graphics, text, or images on a television monitor or screen 205 to present live information and prerecorded content as exemplified in FIG. 2. The on-demand shopping videos can be or comprise the VOD segments 375 illustrated in FIG. 3, for example.

At Step 605, the transaction server 315 operated by a shopping network 350 determines a current or initial inventory of a widget. At Step 610, a content creator 355, typically compensated by the shopping network 350, creates an on-demand video program to market the widget. The video program comprises prerecorded content and a field or window 220 for presentation of dynamic information that changes in response to purchasing events.

At Step 615, the VOD server 305 stores the video program for remote accessibility. At Step 620, a cable system or the VOD network 310 offers the video program to consumers. At Step 625, consumer viewers select the video program for viewing, thereby expressing a potential interest in purchasing or acquiring the widget.

At Step 630, the VOD server 305 downloads the video program via the VOD network 310 to the set top boxes 320 of the consumers who requested that program. At Step 635, the set top boxes 320 insert the initial inventory data in the window 220, thereby initializing the program with real data or a measured value. Thus, the set top boxes 320 receive signals carrying prerecorded content that comprises a sales presentation.

At Step 640, each the set top boxes 320 send video signals to their associated televisions 200. Those signals carry image data representative of both the prerecorded content and the initial inventory data. Thus, the television monitors 205 present images 210, 215 based on or comprising prerecorded content and other images 220, 225, 230, 235, 240 based on or comprising inventory data.

At Step 645, consumers place orders for the widget in response to viewing the downloaded video. Thus, purchase events occur. At Step 650, the ISTM 335 tracks the incoming orders and updates its inventory records to reflect those orders. For example, the ISTM 335 could compute a new inventory count as an old inventory count minus the number of orders received.

At Step 655, the transaction server 315 broadcasts the new inventory count on the transaction network 340. At Step 660, the set top boxes 320 receive signals carrying inventory data that is live, dynamic, or changes in response to sales events. The set top boxes 320 that are actively showing the widget video receive the broadcast inventory count and insert that data into the applicable fields 230 of the video. That is, the set top boxes 320 process incoming signals that carry live data and incoming signals that carry prerecorded video content and integrate the live data with the prerecorded video content to provide a unified video presentation.

The video continues showing the prerecorded content with live updates to the fields or images 220, 225, 230, 235, 340 that are responsive to live data. In other words, some aspect of the video presentation changes in response to a purchasing event that may occur either at the residence 325 of that video presentation or another consumer site on the VOD network 310.

At Step 665 the ISTM 335 determines whether widget inventory has depleted or alternatively has dropped below a threshold. If salable inventory remains, Process 600 iterates Steps 645-665 until inventory is insufficient for sales and marketing to continue unabated.

Step 670 follows Step 665 when widget inventory has been depleted. At Step 670, the transaction server 315 sends notification to the set top boxes 320 that the current supply of widgets has sold out and that the widget video will be ending. The set top boxes 320 output video signals that cause the television monitors 205 to display that notification to the consumers.

At Step 675, the set top boxes 320 terminate the presentation of the video program. Process 600 ends following Step 675.

In many situations, the shopping network 350 can financially benefit by increasing the consumer's attentiveness to the downloaded video and to the promotions or sales offers that the video presents. In one exemplary embodiment of the present invention, in connection with a video presentation, a consumer or a viewer is queried or questioned about some aspect of the video presentation or about a product that the video features. The question, which may concern either live sales and inventory information or prerecorded content, can cause the consumer to pay close attention to the video or to become immersed in a video presentation.

In one exemplary embodiment, the question transmits to the viewer via the transaction network 340, and the transaction network and the VOD network 310 may be isolated or segregated from one another. In one exemplary embodiment, the question and the on-demand content arrive at the residence 325 via propagation on a common medium or a common network, such as the VOD network 310.

In one exemplary embodiment of the present invention, awareness to or effectiveness of a VOD shopping video results from using one or more of the methods or systems for increasing viewership or immersion disclosed or taught in U.S. patent application Ser. No. 10/976,149, which was filed on Oct. 28, 2004, published as U.S. Patent Application Publication Number 2005/0060232 on Mar. 17, 2005 to Maggio, and entitled “Method and System for Interacting with a Writing,” the entire contents of which are hereby incorporated by reference. For example, a CR A̅V advertisement; communication, or question can accompany a downloaded video, and a consumer can receive a reward for properly responding to a question. That is, in an exemplary embodiment of the present invention, the CR A̅V methodology for advertising, sales, and promotional, which is taught in U.S. patent application Ser. No. 10/976,149, can be applied to on-demand shopping videos.

Thus, to increase viewership, attention, and immersion, a CR A̅V question about one or more on-demand sales presentations or video segments can follow delivery of those presentations or segments. One or more correctly responding consumers will receive or win something of value, which may include the very items being offered for sale.

The awarding of a CR A̅V prize can be delayed until a predetermined number of consumers have accessed or watched a video segment. Alternative arrangements for staging an award include, without limitation, at a scheduled date, in connection with a marketing campaign, upon an occurrence of an event, or based on a calculation. The calculation could be one prize awarded for every thousand viewers, whereby each viewer perceives a one-in-one-thousand (1:1000) chance of winning.

This “simulated drawing” methodology can entice a consumer with the possibility of instant gratification and with the potential to know right away if her or she has won. Over time, the shopping network 350 can refine the loss-to-win or prizing-to-exposure ratio, arriving at a calculus that best serves the network's financial objectives.

Referring now to FIG. 7, this figure illustrates a handheld remote control device 330 that presents a consumer with questions 720 about a shopping video in accordance with an exemplary embodiment of the present invention. This figure illustrates an exemplary scenario for using the remote control 330 of FIG. 3 to interact with remotely accessed video content and/or dynamic data associated with a shopping video.

The remote control 330 sends control signals to the television 200 and to the set top box 320 to adjust volume and to select remotely accessible videos according to user input. A consumer viewer can also use the remote control 330 to order a product featured in a video. Additionally, the consumer make an entry on the remote control 330 in response to a question 720 about a VOD video. The consumer can receive a prize or a reward for entering a correct answer to the question 720, for example.

In accordance with the illustrated scenario, a home shopping video or an on-demand video that features the “Example 1” brand of soup is playing, is about to play, or has recently concluded. “Example 1” is a fictitious and exemplary brand name. When the consumer selects the soup video from the Food Section of the Video Categories 105 that FIG. 1 illustrates, the VOD server 305 downloads the video. As discussed above, the transaction server 315 sends dynamic information for showing on the television 200 in connection with presentation of the video.

The transaction server 315 further sends over the transaction network 340 a message comprising a CR A̅V communication or question 720 about the soup video to the remote control 330. The set top box 320 receives the transmitted message and forwards it to the remote control 330. When the remote control 330 receives the message, the communication appears on the display 706.

The communication offers the consumer a can of Example 1 chicken soup for correctly answering a CR A̅V question 720 regarding the content of the on-demand shopping video. That content includes a recipe that has a soup ingredient. The CR A̅V question 720 specifically asks, “Does the featured recipe call for two cans of Example 1 chicken soup or three cans of Example 1 tomato soup?”

The question 720 stimulates or induces the consumer to pay close attention to the video presentation to compose a correct response, thereby immersing the consumer in a sales pitch, promotion, or offer for Example 1 brand. If the consumer enters the correct response, which is “two cans of Example 1 mushroom,” the remote control 330 displays notification of winning a can of Example 1 chicken soup.

The transaction server 315 can initiate mail delivery of a coupon redeemable for the can of chicken soup or direct mail delivery of that product, for example. Alternatively, the transaction server 315 can transmit a message to a grocery store frequented by the consumer, notifying the store to provide a free can of Example 1 chicken soup at the consumer's next shopping trip. As yet another example, the transaction server 315 can communicate a code that the consumer can use to redeem the reward in connection with viewing another on-demand shopping video.

In one exemplary embodiment, the transaction server 315 electronically credits an account in response to receipt of a response that is correct or that meets some other criterion. Such an account can be a bank account of the consumer, such as a checking or savings account. Alternatively, the account can be a reward account, dedicated to maintaining a record of entitled rewards that have yet to be redeemed or collected.

If the consumer enters an incorrect response to the CR A̅V question 720, the remote control 330 can display another question that continues to immerse the consumer in advertisements, promotions, or sales offers for products carrying the Example 1 brand. For example, a follow up question could ask, “Does the recipe require cooking two cans of Example 1 mushroom soup for ten minutes or for twenty minutes?” Continued interaction can extend the period of time that the consumer is immersed in sales offers for Example 1 products.

While FIG. 7 illustrates a textual presentation of the CR A̅V question 720 on the remote control 330, exemplary embodiment of the present invention can support a variety of other presentation formats. The CR A̅V question 720 may be spoken, printed, displayed, heard, or communicated by any other possible means, or any combination of possible means.

As an alternative to the remote control 330, the consumer can view the question 720 and/or enter a response on a land-line phone, a cellular telephone, a personal digital assistant (“PDA”), an interactive TV, an Internet computer, an interface to a hospitality industry private network (i.e., a sports bar and pub device), a print medium, or any other suitable device. In one exemplary embodiment, the consumer can prepare a printed response by composing a handwritten or typewritten response on a paper that is mailed to the transaction server 315 or to a representative of the shopping network 350. The CR A̅V question 720 can also appear on the television monitor 205 or on a nearby home computer system, for example.

The content of the question 720 can change based on sales events, inventory changes, or dynamic information that the ISTM tracks. For example, a query can ask the consumer to enter a current sales rate or inventory level that is showing on the television 200 at the time of query presentation.

The query can precede, follow, or be aligned with a selected portion or part of the on-demand video content. In this manner, the viewing consumer can readily correlate or associate the query with the content section to which it pertains. Further, the shopping network 350 or some advertiser or promoter can use the query to emphasize and heighten attentiveness to selected portions of the on-demand content, such as a particular aspect of a featured product.

In one exemplary embodiment, the on-demand video comprises a plurality of commercials or advertisements, and the query is about a selected one of the commercials or advertisements. The query may further be about a selected portion of a selected one of the commercials or advertisements, such as a specific advertised product.

In one exemplary embodiment, the video presentation includes an on-screen counter that increments as the video plays, thereby providing an indication of the position of the video that the consumer is viewing. That is, an identifier appears on the television monitor 205 to identify the segment of the video that is playing at any particular time. The CR A̅V communication 720 can reference a specific identifier value, thereby incentivizing the consumer to focus on a selected portion of the video. Furthermore, the consumer may be enticed to replay a section of the video that correlates to the specific identifier value.

CR A̅V questions 720 can evolve in complexity or subject in a manner that coincides with the video's duration or that is aligned to the presentation flow of the on-demand video. The on-screen counter, or a graphic that changes from one state to another state as the video plays, can correspond to the evolution of the questions 720.

In one exemplary embodiment, questions change or evolve based on the amount of content viewed. Questions can become more difficult or easier to answer in response to extending the viewing time, for example.

In one exemplary embodiment, the consumer can watch the video with knowledge about the sections of the video that will present questions 720. For example, an opening segment of the video can present a list or index of the counter values at which questions will appear. Informing the consumer about the locations or timing of the questions 720 in the video helps avoid any tendency of the consumer to wait until the end of the video to place an order.

In one exemplary embodiment, the counter is tied to a clock or provides an indication of time. That is, the counter can reflect the actual date and time that a consumer is watching the video. In this situation, the counter provides live time information that can supplement prerecorded content. The counter can be used for correlating a timestamp to the CR A̅V question 720, an answer to the CR A̅V question 720, or a purchase event.

In one exemplary embodiment, the counter is a unique identifier or a code that the system 300 broadcasts across the transaction network 340 at designated time intervals or in response to a unscheduled occurrence of a selected event. The value of that identifier can change over time based on time passage or event occurrences.

An opening section of a CR A̅V interaction can require the consumer to input the current unique identifier as well as a personal identification number that differentiates that consumer from other consumers. In this exemplary situation, the question 720 can be tailored to the broadcast identifier and/or the identity of the consumer that is the recipient of the question 720. Consumers with different purchasing histories, demographics, or patterns of viewing specific genres of videos may receive unique, tailored, or custom questions 720.

The CR A̅V question 720 can be presented to the consumer in connection with order placement. For example, question presentation can occur when the viewer logs in to an ordering system or makes an expressed attempt to place the order. Alternatively, an answer to the question 720 can be solicited before or after the consumer verifies or confirms the order or executes a payment transaction.

In addition to qualifying the consumer for a chance to receive a prize, the submission of an answer to the question 720, can earn the consumer a discount or value applicable to the order. For example, the consumer can receive free shipping for the order, a coupon for another product featured on another video, and entry into a drawing for a car. In one exemplary embodiment, the consumer receives a partial award, and the consumer must perform an additional step, such as answering another question 720 within designated timeframe, to receive the entire reward.

For example, an on-demand video may offer an on-sale price of $699 for a fishing motor that has a manufacturer's suggested retail price of $999. The video may present a message informing viewing consumers that a correct response to the question 720 will entitle the consumer to free shipping. Text shown on the television monitor 205 might state “Free shipping if you get the CR A̅V question shown on your remote control correct.”

In one exemplary embodiment, consumers can answer CR A̅V questions 720 to receive refunds on or payment towards previously placed orders. Thus, a consumer can place an order for a product that an on-demand video features with the knowledge that he or she has an opportunity to receive that product for free or at a discount by answering some CR A̅V question 720 at a future date. Such a retroactive reward, helps address the tendency of some consumers to delay ordering a product of interest until favorable purchasing terms can be obtained by submitting a correct response. In words, consumers are incentivized to purchase early rather than to delay.

In one exemplary embodiment, some aspect of the CR A̅V question 720 or the CR A̅V interaction changes based on dynamic inventory or sales data or other live information. For example, the shopping network 350 can elect to present CR A̅V questions 720 when inventory moves above or below a threshold in connection with a purchasing event initiated from an arbitrary location on the transaction network 340 or the VOD network 310. Alternatively, prize values or the terms associated with receiving a reward can change based on live data, purchasing volume, or some other selected condition.

In a phone-ordering environment, ordering consumers can receive priority for answering the question 720 over consumers that are answering with no expressed intention of making a purchase. In this manner, when call volume is high, ordering consumers can experience less delay in receiving telephonic service than non-ordering customers may experience. That is, a call-processing system that processes answers to CR A̅V questions 720 from consumers placing orders and from other consumers that are not placing orders can differentiate between those two classes of consumers and move the consumers placing orders to the front of a call-processing queue.

Prioritizing the handling of responses to CR A̅V communications 720 is not limited to a telephonic communication environment. Rather, VOD systems 300 that communicate with consumers via the Internet or another communication infrastructure can determine or assign an order for handling responses to CR A̅V communications 720 that financially benefits the shopping network 350.

A CR A̅V communication 720, or a series of CR A̅V communications 720, may also be the basis for an on-demand video or a home shopping video. That is, an on-demand video can feature advertisements and questions 720 without providing a direct sales channel for products or services that are the subjects of those advertisements or questions 720.

Turning now to FIG. 8, this figure illustrates a flow diagram of a process 800, entitled Interact with On-Demand Video, in which a consumer interacts with on-demand video content in accordance with an exemplary embodiment of the present invention. The on-demand video content can comprise prerecorded material, including a sales pitch for a product, and material or data that changes in response to purchasing activities initiated by one or more viewing individuals.

At Step 805, a consumer or another viewer, selects a video clip, program, or segment for access from a remote site that comprises the VOD server 305, a video archive, a machine-readable medium, or a facility for storing a library of videos. A CR A̅V logo or another indicator or identifier can alert the viewer that the video is interactive. The selected video transmits via electronic, electromagnetic, or optical signal transmission to a television system that comprises a set top box 320 and a television 200. The television 200 plays and the consumer reviews, watches, or views the video.

At Step 810, the transaction server 315 transmits a message that comprises a query 720 about the selected video to the set top box 320. The VOD server 305 and the transaction server 315 can communicate with one another via the PSTN, a dedicated communication link, the Internet, or another communication path. The VOD server 305 can use that communication path to transmit a prompt to the transaction server 315 that initiates transmission of the query message.

The transaction server 315 or another remote computer can generate the query 720 based on a demographic profile of the consumer. The set top box 320 can generate the demographic profile in connection with monitoring the consumer's viewing habits and video selections.

As an alternative to the query 720 directly concerning the video, a query can concern another subject. For example, a query can comprise a trivia question or a question about another product that the shopping network 350 is interested in promoting.

At Step 815, the set top box 320 receives the query message from the transaction server 315 and sends it to the remote control 330 for receipt at Step 820. In response to receiving the query message, the remote control 330 displays the query 720 to the consumer.

At Step 825, the consumer studies, thinks about, absorbs, or becomes immersed in the video. The consumer composes or prepares a response to the query 720 and enters the response on the remote control 330. As the consumer contemplates the query 720 and thinks about the video content, the consumer becomes immersed in that content.

At Step 830, the remote control 330 transmits the consumer's entry to the set top box 320, which forwards it to the transaction server 315 at Step 835. In receipt of the consumer's response, the transaction server 315 compares it to the correct entry at Step 840.

At Step 845, the Process 800 branches according to whether the consumer's response is correct or proper or complies with another criterion. If the consumer has submitted an incorrect response, Step 850 follows Step 845, and the transaction server 315 sends a losing notification to the remote control 330 via the set top box 320.

At Step 855, the remote control 330 displays a message that the response is wrong and offers the consumer an opportunity to answer another question. To continue immersing the consumer in advertising content, the remote control 330 can offer the consumer repeated opportunities for answering queries until the consumer answers correctly and becomes eligible to win a prize, for example. In one exemplary embodiment, submitting an answer to the query 720, either a correct answer or an incorrect answer, qualifies the consumer for entry into a lottery or another contest.

If the consumer has submitted the correct response, then Step 860 rather than Step 850 follows Step 845. At Step 860, the transaction server 315 sends a winning notification to the remote control 330 by way of the set top box 320. At Step 865, the remote control 330 displays an announcement that the consumer has submitted a winning response and provides the consumer with information about collecting the prize. The information can comprise details about redeeming a reward certificate, for example.

At Step 870, the transaction server 315 sends the reward certificate to the consumer. In one exemplary embodiment, the certificate arrives electronically, such as via an e-mail attachment.

The transaction server 315 can alternatively initiate mailing a physical prize certificate to the residence 325 of the consumer. As another example, the transaction server 315 can send a notification to a business, such as a store that the consumer routinely visits, for prize redemption. The consumer's prize can be a monetary reward, an advertised product, or a premium, for example. As an alternative to a physical or monetary prize, the consumer's reward for submitting a correct answer can be entry into a drawing for a larger prize, such as an automobile, vacation, or significant cash purse. As yet another example, the consumer can receive a quantity of points that can be accumulated with other points towards receiving a moderate prize, for example a household appliance or a stock of a consumable product.

Following the execution of either Step 870 or Step 855, according to whether the consumer submitted a correct response, Process 800 ends.

Turning now to FIG. 9, this figure illustrates a flow diagram of a process 900 for offering a consumer a categorized list of on-demand shopping videos in accordance with an exemplary embodiment of the present invention. As discussed above with reference to FIG. 4, Process 900, which is entitled Offer Organized Videos, can replace Steps 415, 420, and 425 of Process 400.

At Step 905, the shopping network 350 categorizes each on-demand shopping video in a collection, group, library, or set of on-demand videos. Creating the categorization 105 can comprise organizing the on-demand videos or associating each of the on-demand videos with a category identifier. Each category can contain on-demand videos that appeal to a common demographic of consumer or viewer or that make sales offers for products or services that have a common feature, function, usage, operability, or price range, for example. For example, each category could contain sporting goods products, food products, boating products, fishing products, makeup or cosmetic products, apparel products, food products, or furniture products, to name a few representative examples.

At Step 910, the VOD server 305 stores a copy of each categorized on-demand shopping video. The stored videos can be or comprise the VOD segments 375 illustrated in FIG. 3, for example.

At Step 915, the consumer submits a request or a prompt to download a listing of the categories of on-demand shopping videos that are available for downloading. The consumer could make the request via an entry into the remote control 330, for example. The request transmits to the VOD server 305 via the VOD network 310 or via the transaction network 340 and the shopping network 350.

At Step 920, the VOD server 375 receives the request and transmits the requested list of video categories to the consumer via the VOD network 310. Alternatively, the transaction server 315 can receive and process the request.

At Step 925, the consumer receives and reviews the category list. The television 200 or an integrated display on the remote control 330 may display the category list, for example. The consumer selects a particular category within the list based on a purchase interest or a browsing interest, for example. Browsing electronic categories can emulate “window shopping” in a bricks-and-mortar shopping mall without entering any particular specialty store or department. The consumer could identify a specific category by making an entry into the remote control 330, for example.

At Step 930, the VOD server 305 receives the consumer's category selection. In response, the VOD server 305 transmits a list of each of the on-demand shopping videos within the selected category. The list may contain a brief description of each video in the category and/or a description of the featured products.

At Step 935, the consumer receives the requested list of on-demand videos within the specified category. After reviewing the list, the consumer selects one or more specific on-demand shopping videos for downloading and submits a download request to the VOD server 305.

At Step 940, the VOD server 305 downloads the selected on-demand video to the set top box 320. At Step 945, the television 200 plays, presents, or shows the downloaded video content while the consumer views that content. Viewing the video content can comprise viewing dynamic or live content and prerecorded content on a common television monitor at essentially the same time. Process 900 ends following Step 940.

In one exemplary embodiment of the present invention, one user request prompts the VOD server 305 to provide the consumer with an on-demand video guide or index. The guide can show the consumer all of the on-demand video categories and a list of the videos within each category. For example, Steps 915, 920, 925, and 930 could be integrated into a single step. The consumer can select one or more videos from the guide for targeted downloading. In one exemplary embodiment, a user request prompts the VOD server 305 to download the category window 100 and its associated operability, as shown in FIG. 1 and discussed above.

In one exemplary embodiment of the present invention, Process 900 emulates or simulates certain aspects of the traditional bricks-and-mortar shopping experience without the inconvenience of leaving the residence 325 and physically traveling to a traditional shopping mall.

Although specific embodiments of the present invention have been described above in detail, the description is merely for purposes of illustration. Various modifications of, and equivalent steps corresponding to, the disclosed aspects of the exemplary embodiments, in addition to those described above, also can be made by those skilled in the art without departing from the spirit and scope of the present invention defined in the following claims, the scope of which is to be accorded the broadest interpretation so as to encompass such modifications and equivalent structures.

What is claimed is:

1. A method for updating content of an on-demand video program, comprising the steps of:
in response to a user request, receiving an on-demand video program that offers a product for sale;
receiving initial inventory data about the product;
showing the on-demand video program and the initial inventory data;
receiving updated inventory data, reflecting at least an order for the product; and
in response to receiving the updated inventory data, replacing the shown initial inventory data with the updated inventory data.

2. The method according to claim 1, wherein the step of receiving the on-demand video program comprises receiving the on-demand video program at a set top box.

3. The method according to claim 1, wherein the set top box is coupled to a television screen, and
wherein the step of showing the video program and the initial inventory data comprises showing the video program and the initial inventory data on the television screen, and
wherein the step of replacing the shown initial inventory data with the updated inventory data further comprises showing the updated inventory data on the television screen.

4. The method according to claim 1, wherein the step of replacing the shown initial inventory data further comprises replacing the shown initial inventory data with the updated inventory data while showing the video program.

5. The method according to claim 1, wherein the step of receiving the on-demand video program comprises receiving the on-demand video program via the Internet, and
wherein the step of receiving the updated inventory data further comprises receiving the updated inventory data via the Internet.

6. The method according to claim 1, wherein the step of receiving the on-demand video program comprises receiving signals from a first network, and wherein receiving the updated inventory data comprises receiving signals from a second network.

7. The method according to claim 6, wherein the first network is segregated from the second network.

8. The method according to claim 6, wherein the first network comprises a video distribution network and wherein the second network comprises a packet-switched network.

9. The method according to claim 6, wherein exactly one of the first network and the second network comprises a packet-switched network.

10. The method according to claim 1, further comprising the steps of:
receiving a second user request from a remote control device to show the updated inventory data; and
sending a prompt to a remote server in response to receiving the second user request,
wherein the step of receiving the updated inventory data comprises receiving the updated inventory data from the remote server in response to the sent prompt.

11. The method according to claim 1, wherein the step of receiving the updated inventory data comprises receiving the updated inventory data in response to a predetermined interval of time elapsing after receiving the initial inventory data.

12. The method according to claim 1, wherein the step of receiving the updated inventory data comprises receiving the updated inventory data in response to inventory of the product dropping below a predetermined threshold.

13. The method according to claim 1, wherein the step of receiving the on-demand video program further comprises receiving the on-demand video from a video archive that contains shopping videos categorized according to product usage.

14. The method according to claim 1, further comprising the step of offering a plurality of on-demand video programs, each featuring a respective product for sale and each categorized according to product type, wherein the user request comprises a selection of one of the on-demand video programs.

15. The method according to claim 1, wherein showing the initial inventory data comprises inserting the initial inventory data in a field of the on-demand video program, and
wherein the replacing step comprises inserting the updated inventory data in the field.

16. The method according to claim 1, wherein receiving the on-demand video program comprises receiving the on-demand video program from a first server, and wherein receiving the updated inventory data comprises receiving the updated inventory data from a second server.

17. The method according to claim 1, further comprising the step of, in response to inventory of the product dropping below a threshold, notifying a viewer of the on-demand video program that supply of the product is limited.

18. The method according to claim 1, further comprising the steps of:
comparing the updated inventory data to a threshold; and
if the updated inventory data is below the threshold, presenting a second on-demand video program that presents a sales offer for a second product

19. The method according to claim 18, wherein the second product and the first product have common features.

22. A method for presenting product information to viewers, comprising the steps of:
receiving requests from the viewers for an on-demand video about a product;
in response to the received requests, transmitting the on-demand video for presentation to the viewers;
receiving orders for the product in response to presenting the on-demand video to the viewers;
determining inventory data for the product that accounts for the received orders; and
sending a notification to at least one of the viewers about the determined inventory data during presentation of the on-demand video to the viewers.

23. The method according to claim 22, further comprising the step of determining whether the inventory data is below a predetermined threshold,
wherein the sending step comprises offering the at least one of the viewers a second video featuring a second product if the inventory data is below the predetermined threshold.

24. The method according to claim 22, wherein the notification comprises a message about an inventory limitation.

25. The method according to claim 22, wherein the notification comprises a characterization of an amount of the product available for purchase.

26. The method according to claim 22, further comprising the step of inserting the determined inventory data into a field of the on-demand video during the presentation of the on-demand video to the viewers.

27. The method according to claim 22, further comprising the step of presenting the viewers with on-demand video offerings categorized according to product type, wherein the requested video on-demand is one of the on-demand video offerings.

28. The method according to claim 22, wherein the step of transmitting the on-demand video comprises transmitting signals over a first communication network, segregated from a second communication network, and
wherein the step of sending the notification comprises transmitting signals over the second communication network.

29. The method according to claim 28, wherein the first communication network comprises a video-on-demand network and wherein the second communication network comprises an Internet protocol network.

30. The method according to claim 28, wherein the first communication network comprises the Internet and wherein the second communication network comprises an telephony network.

31. A method for providing a viewer with an opportunity to purchase a product, comprising the steps of:
receiving a request for a video that comprises an offer to sell the product;
transmitting the video to a television system in response to receiving the request;
determining inventory data for the product; and
transmitting the inventory data to the television system, wherein the television system is operable to receive the transmitted video and the transmitted inventory data and to change a presentation of the video based on the inventory data.

32. The method according to claim 31, wherein changing the presentation of the video comprises ending the presentation of the video if the inventory data indicates an inventory shortage.

33. The method according to claim 31, wherein changing the presentation of the video based on the inventory data comprises changing the presentation of the video in response to a change in the inventory data.

34. The method according to claim 31, wherein determining the inventory data comprises updating the inventory data during a presentation of the video in response to an occurrence of a purchasing event.

35. The method according to claim 31, wherein the video comprises an on-demand video.

36. The method according to claim 31, wherein the video comprises prerecorded content, wherein the inventory data comprises dynamic data, and wherein changing the presentation comprises simultaneously presenting the prerecorded content and the dynamic data on the television system.

37. The method according to claim 31, wherein the step of transmitting the video further comprises transmitting video-encoded signals over a first network, and
wherein the step of transmitting the inventory data further comprises transmitting signals encoded with the inventory data over a second network.

38. The method according to claim 37, wherein the first network is segregated from the second network.

39. The method according to claim 37, wherein the first network is isolated from the second network, and wherein one of the first network and the second network comprises the Internet.

40. The method according to claim 37, wherein the first network or the second network is operable to transmit communications using Internet protocol.

41. A method for presenting content on a television, comprising the steps of:
in response to a user request, receiving first signals carrying prerecorded video content that comprises a sales presentation;
receiving second signals carrying dynamic content generated in response to a sales event;
integrating the dynamic content and the prerecorded video content in response to processing the first signals and the second signals; and
showing the integrated dynamic content and prerecorded video content on the television.

42. The method according to claim 41, wherein the step of receiving the first signals comprises downloading an on-demand shopping video from a remote server to a residence.

43. The method according to claim 41, wherein the dynamic content comprises inventory data or sales data.

44. The method according to claim 41, further comprising the step of changing the dynamic content showing on the television in response to a second sales event.

45. The method according to claim 41, wherein the sales event comprises a change in availability of an item featured in the sales presentation.

46. The method according to claim 41, wherein the step of receiving the second signals comprises receiving the second signals carrying dynamic content generated in response to an occurrence of the sales event while showing the prerecorded video content on the television.

47. The method according to claim 41, wherein receiving the first signals comprises receiving the first signals from a first network, and
wherein receiving the second signals comprises receiving the second signals from a second network.

48. The method according to claim 47, wherein the first network is segregated from the second network.

49. The method according to claim 41, wherein the dynamic content comprises live content.

50. A method for presenting dynamic content during presentation of an on-demand video program, comprising the steps of:
transmitting a request for the on-demand video program;
in response to the transmitted request, receiving first signals conveying prerecorded content stored on a machine-readable medium;
in response to the transmitted request, receiving second signals conveying dynamic content;
processing the first received signals and the second received signals; and
in response to the processing step, presenting the dynamic content on a video monitor while presenting the prerecorded content on the video monitor.

51. The method according to claim 50, further comprising the steps of:
changing the dynamic content during presentation of the prerecorded content on the video monitor;
receiving the changed dynamic content from a communication network; and
presenting the changed dynamic content while presenting the prerecorded content on the video monitor.

52. The method according to claim 50, wherein the step of receiving the first signals further comprises receiving the first signals from a first network, and
wherein the step of receiving the second signals comprises receiving the second signals from a second network.

53. The method according to claim 52, wherein the first network is segregated from the second network.

54. The method according to claim 52, wherein the first network and the second network are isolated from one another.

55. A method for identifying on-demand videos offering products for sale, comprising the steps of:
identifying a first plurality of on-demand videos that offer for sale products having a first feature in common;
identifying a second plurality of on-demand videos that offer for sale products having a second feature in common;
receiving a request from a remote viewer to identify on-demand videos offering for sale products having a selected one of the first feature and the second feature;
if the received request is to identify on-demand videos offering for sale products having the first feature, identifying the first plurality of on-demand videos to the remote viewer for access over a communication network; and
if the received request is to identify on-demand videos offering for sale products having the second feature, identifying the second plurality of on-demand videos to the remote viewer for access over the communication network.

56. The method according to claim 55, wherein the first plurality and the second plurality are mutually exclusive with respect to one another.

57. The method according to claim 55, wherein the first plurality comprises one of the on-demand videos and wherein the second plurality comprises the one of the on-demand videos.

58. The method according to claim 55, wherein the first plurality comprises on-demand videos about one of sporting goods products, boating products, fishing products, makeup products, apparel products, food products, and furniture products, and
wherein the second plurality comprises on-demand videos about a different one of sporting goods products, boating products, fishing products, makeup products, apparel products, food products, and furniture products.

59. The method according to claim 55, wherein the on-demand videos comprise a collection of shopping videos stored on a computer-readable medium.

60. The method according to claim 55, wherein the first plurality comprises a first group of the shopping videos selected to appeal to consumers having a first demographic profile, and wherein the second plurality comprises a second group of the shopping videos selected to appeal to consumers having a second demographic profile.

61. The method according to claim 55, wherein the step of identifying the first plurality of on-demand videos to the remote viewer comprises transmitting a listing of the first plurality of on-demand videos to the remote viewer over the communication network, and
wherein the step of identifying the second plurality of on-demand videos to the remote viewer comprises transmitting a listing of the second plurality of on-demand videos to the remote viewer over the communication network

62. The method according to claim 55, further comprising the step of downloading an on-demand video, selected from one of the first plurality of on-demand videos and the second plurality of on-demand videos, from an on-demand video archive to a television system via the communication network.

63. The method according to claim 62, wherein the communication network comprises a packet-switched network.

64. The method according to claim 62, wherein the communication network comprises a telephone network.

65. The method according to claim 62, wherein the step of downloading the selected on-demand video further comprises transmitting Internet-protocol signals.

66. The method according to claim 62, wherein the communication network comprises a wireless network.

67. The method according to claim 55, further comprising the steps of:
receiving a request from the remote viewer for an on-demand video selected from one of the first plurality of on-demand videos and the second plurality of on-demand videos; and
in response to receiving the request for the selected on-demand video, downloading prerecorded video content from a machine-readable medium to a television system via the communication network.

68. The method according to claim 67, further comprising the step of in response to receiving the request for the selected on-demand video, transmitting dynamic data to the television system, wherein the television system is operative to receive the dynamic data and the prerecorded video content for integrated display to the remote viewer.

69. The method according to claim 68, wherein the dynamic data comprises live content.

70. The method according to claim 68, wherein the step of transmitting dynamic data comprises transmitting signals encoded with the dynamic data over a second communication network.

71. The method according to claim 70, wherein the communication network is segregated from the second communication network.

72. The method according to claim 68, wherein the dynamic data comprise inventory data.

73. The method according to claim 55, further comprising the steps of:
monitoring for an occurrence of a sales event initiated by the remote viewer; and
transmitting a notification to a television associated with the remote viewer in response to detecting the occurrence of the sales event.

75. A method for providing remote access to a plurality of video segments, each featuring a respective product for sale, comprising the steps of:
storing the plurality of video segments on a storage medium;
associating video segment in the plurality of stored video segments with at least one of a plurality of product categories;
receiving a first electronic message, from a remote site, identifying a selected product category in the plurality of product categories;
in response to receiving the first electronic message, transmitting to the remote site a list of each video segment in the plurality of video segments that is associated with the identified product category;
receiving a second electronic message, from the remote site, identifying a selected video segment of the transmitted list; and
in response to receiving the second electronic message, transmitting the selected video segment to a television system at the remote site.

76. The method according to claim 75, wherein the step of transmitting the selected video segment to the remote television system comprises transmitting video signals over a packet-switched network.

77. The method according to claim 75, wherein the step of transmitting the selected video segment to the remote television system comprises transmitting video signals over a network using Internet protocol.

78. The method according to claim 75, wherein the step of receiving the first electronic message comprises receiving signals from a first network, segregated from a second network, and wherein the step of transmitting the selected video segment comprises transmitting signals over the second network.

79. The method according to claim 78, wherein exactly one of the first network and the second network comprises the Internet.

80. The method according to claim 75, further comprising the steps of:
in response to the step of transmitting the selected video segment to the remote television system, receiving an order for the featured product of the selected video segment;
in response to receipt of the order, determining whether an inventory condition exists; and
if an inventory condition exists, disassociating the selected video segment from at least one category in the plurality of product categories.

81. The method according to claim 75, wherein the step of transmitting the selected video segment comprises transmitting prerecorded content, stored on a machine-readable medium, to the television system.

82. The method according to claim 81, further comprising the step of transmitting dynamic content to the television system for display in connection with display of the prerecorded content.

83. The method according to claim 81, further comprising the steps of:
generating dynamic data in response to a purchasing event; and
transmitting the dynamic data to the television system.

84. The method according to claim 81, wherein the method further comprises the steps of:
generating data while the prerecorded content is showing on the television system;
transmitting the generated data to the television system; and
presenting the transmitted data on the television system while the prerecorded content is showing on the television system.

85. The method according to claim 84, wherein the step of transmitting prerecorded content comprises transmitting the prerecorded content to the television system via a first network, isolated from a second network, and
wherein step of transmitting the generated data comprises transmitting the generated data to the television system via the second network.
